(19) United States
(12) Patent Application Publication
(10) Pub. No.: US 2009/0284822 A1
(43) Pub. Date: Nov. 19, 2009

(54) PHASE CALIBRATION METHOD AND DEVICE USING THE SAME AND DISTANCE MEASURING EQUIPMENT

(75) Inventors: Xin DU, Shenzhen (CN); Xin Wu, Shenzhen (CN); Zhi Chou, Shenzhen (CN)

Correspondence Address: HAMRE, SCHUMANN, MUELLER & LARSON, P.C., P.O. BOX 2902, MINNEAPOLIS, MN, 55402-0902, US

(73) Assignee: BOSSYARD TECHNOLOGY LIMITED, Shenzhen (CN)

(21) Appl. No.: 12/189,314

(22) Filed: Aug. 11, 2008

(30) Foreign Application Priority Data
May 16, 2008 (CN) 200810067250.1

(51) Int. Cl. G02F 1/01

(52) U.S. Cl. 359/279

(57) ABSTRACT

The present invention provides a phase calibration method, device, and equipment. The method comprises the steps of: a first light beam emitter generating a first light-wave into a target object, the first light-wave being reflected at the target object and flying back onto a receiver, wherein the first light-wave, as an external beam path signal, is modulated by a first high-frequency oscillation signal; a second light beam emitter emitting a second light-wave into the receiver, wherein the second light-wave, as an internal beam path signal for fundamental phase reference, is modulated by a second high-frequency oscillation signal; and the receiver performing a phase comparison between received first light-wave and sequentially received second light-wave therein and exporting a measurement signal with fundamental reference eliminated. The present method achieves phase compensation and calibration, thereby reducing the influence of environmental elements, increasing measuring precision, and thus reducing system cost.

### FIELD OF THE INVENTION

The present invention relates to optoelectronic ranging devices and, more particularly to a phase calibration method, a phase calibration device using the method, and distance measuring equipment.

### BACKGROUND

With the great progress of semiconductor laser and digital circuit since 1980s, long-distance high-precision laser ranging technology has been applied more and more widely to various fields such as electric power, water conservancy, communication, environment protection, architecture, police affairs, fire fighting, blasting, navigation, railway and military anti-terrorism. Phase laser distance-measuring devices in millimeter precision have been increasingly taking a leading position gradually in short-distance laser ranging within 200 meters. In the operation of a laser ranging device based on the theory of phase margin measurement, modulated laser beam of light was irradiated on the target objective and the beam is reflected by the target objective. The phase margin between forward and back course is converted to the distance of the target objective. While this device is applied in short-distance high-precision ranging, the measurement accuracy and precision is influenced by features of inside parts. The higher the precision of the laser-ranging equipment is, the more complicated its circuit is and the more precise parts are needed. Therefore, phase excursion due to the influence of environmental elements such as temperature and equipment working life on properties of parts is unneglectable. Nowadays, many technologies adopt the theory of phase margin compensation of out internal and external light paths to eliminate supplementary phaseshift of circuit systems to ensure that measured data is not influenced by external environment. The theory of phase margin compensation adopted in eliminating supplementary phaseshift is described as below.

Set the phase margins for ranging signals passing an internal light path and an external light path as [symbol] and [symbol] , respectively. Set the supplementary phaseshift generated during signal transmission inside equipment electronic circuit as Δφ. The phase comparison between the internal light path ranging signal [symbol] and the referential signal e₀ and between the external light path ranging signal [symbol] and the referential signal e₀ are:

$$\begin{matrix}= + Δ Φ \\ = + ΔΦ\end{matrix} \}$$

In the above formula, Δφ changes along with equipment operational status. It is a random phaseshift and cannot be calculated preciously. During distance measuring, the internal and external light paths are used alternately in phase measurement. In short period of alternation, supplementary phaseshift can be considered as constant. Therefore, the difference between the phase comparison of the internal and external light paths is taken as the measurement result, that is:

[symbol]

[symbol]

In the above result Φ, the influence of unstable supplementary phase is eliminated, thereby ensuring ranging precision.

Traditional approach adopts the following calibration methods:

(1). Single-emitting and single-receiving system, in which a single route of light beam is transmitted and a single route of light path signals is received. Switch between internal and external light paths is realized by a controllable mechanical device. Phase is calibrated through phase value calculation of internal and external light paths before and after switch so as to eliminate the influence of environmental instability. As a physical mechanical toggle switch is adopted, the mechanical response time is long (usually in millisecond) and real-time adjustment is not allowed. Further, the structure of the device is relatively complex and mechanical abrasion and failure is easily presented, accordingly decreasing working lifetime of the device. Thus, this system is unsuitable for use in industrial precise equipment.

(2). Single-emitting and double-receiving system, in which a single route of light beam is transmitted and internal and external light path signals are received through double routes. These two routes of received signals are processed separately and their phase margins are calculated, thereby eliminating interference in phase due to unstable environment. The system adopts two Avalanche Photo Diodes (APD) in receiving respectively signals from internal and external light paths. As APD is expensive (presently it is usually above 10 USD), two APDs are not only of high cost but also their amplifying circuit on double channels easily results in co-channel interference.

Therefore, the above two solutions have limitation in application.

### SUMMARY

In accordance with an embodiment of the present invention, a phase calibration method is provided for overcoming those problems in above-mentioned technologies, which have a long mechanical response time in circuit, a short working lifetime, a high expense, or are prone to be mechanical failure and generate co-channel interference.

In accordance with an aspect of an embodiment of the present invention, a phase calibration method is provided and comprises the steps of:

a first light beam emitter generating a first light-wave into a target object, the first light-wave being reflected at the target object and flying back onto a receiver, wherein the first light-wave, as an external beam path signal, is modulated by a first high-frequency oscillation signal;

a second light beam emitter generating a second light-wave into the receiver wherein the second light-wave, as an internal beam path signal for fundamental phase reference, is modulated by a second high-frequency oscillation signal; and

the receiver performing a phase comparison between received first light-wave and sequentially received second light-wave therein and exporting a measurement signal with fundamental reference eliminated.

In accordance with another aspect of the embodiment of the present invention, a phase calibration device is provided and comprises: a first light-wave emitter, a second light-wave emitter, and a phase discriminator. The first light-wave emitter is configured (i.e., structured or adapted) for receiving a first high frequency oscillation signal, generating a first light-wave which is modulated by the first high frequency oscillation signal, and emitting modulated first light-wave as an external beam path signal into a target object. The second light-wave emitter is configured for receiving a second high frequency oscillation signal, generating a second light-wave which is modulated by the second high frequency oscillation signal, and emitting modulated second light-wave as an internal beam path signal for fundamental reference. The optoelectrical converter is configured for receiving and converting the second light-wave and/or the first light-wave which is reflected at the target object in sequence, then outputting the converted wave(s). The phase discriminator is configured for separately receiving output signals from the optoelectrical converter and performing a phase comparison between the two signals, then exporting a measurement signal with fundamental reference eliminated.

In accordance with still another aspect of the embodiment of the present invention, a distance measuring equipment is provided and comprises the phase calibration device described above.

The phase calibration method of double-light-path emitting and single-light-path receiving uses two light wave emitters to emit internal and external light path signals, utilizes a signal-receiver to receive the back signals of internal light path signals and external light path signals, and make a phase comparison between these two signals to obtain a phase margin, thereby achieving phase compensation and calibration. The method avoids uncertain phase noise in the circuit due to environmental change, improves measuring precision of laser ranging, increases ranging stabilization of the device and equipment, and reduces influence of environmental elements on ranging error and property requirements on parts so as to reduce system expense and improves laser ranging application in various industries.

Other objects, advantages and novel features of the present invention will become more apparent from the following detailed description when taken in conjunction with the accompanying drawings, in which:

### BRIEF DESCRIPTION OF THE DRAWINGS

FIG. 1 is an exemplary flow chart of the calibration method for phase measurement according to an embodiment of the present invention;

FIG. 2 is a schematic block diagram of a phase calibration device for phase measurement using double-emitting and single-receiving according to another embodiment of the present invention;

FIG. 3 is a schematic block diagram of a phase calibration device for phase measurement according to a first embodiment of the present invention;

FIG. 4 is a schematic block diagram of a phase calibration device for phase measurement according to a second embodiment of the present invention;

FIG. 5 is a schematic block diagram of a phase calibration device for phase measurement according to a third embodiment of the present invention;

FIG. 6 is a schematic block diagram of a phase calibration device for phase measurement according to a fourth embodiment of the present invention;

FIG. 7 is a schematic block diagram of a phase calibration device for phase measurement according to a fifth embodiment of the present invention; and

FIG. 8 is a schematic block diagram of a phase calibration device for phase measurement, and showing a circuit part of the device according to a sixth embodiment of the present invention.

### DETAILED DESCRIPTION OF THE PREFERRED EMBODIMENTS

Objects, advantages and embodiments of the present invention will be explained below in detail with reference to the accompanying drawings. However, it is to be appreciated that the following description of the embodiment(s) is merely exemplary in nature and is no way intended to limit the invention, its application, or uses.

In accordance with an embodiment of the present invention, the phase calibration method of double-light-path emitting and single-light-path receiving uses two light wave emitters to emit internal and external light path signals, utilizes a signal-receiver to receive the back signals of internal light path signals and external light path signals, and make a phase comparison between these two signals to obtain a phase margin, thereby eliminating supplementary phaseshift and achieving phase compensation and calibration.

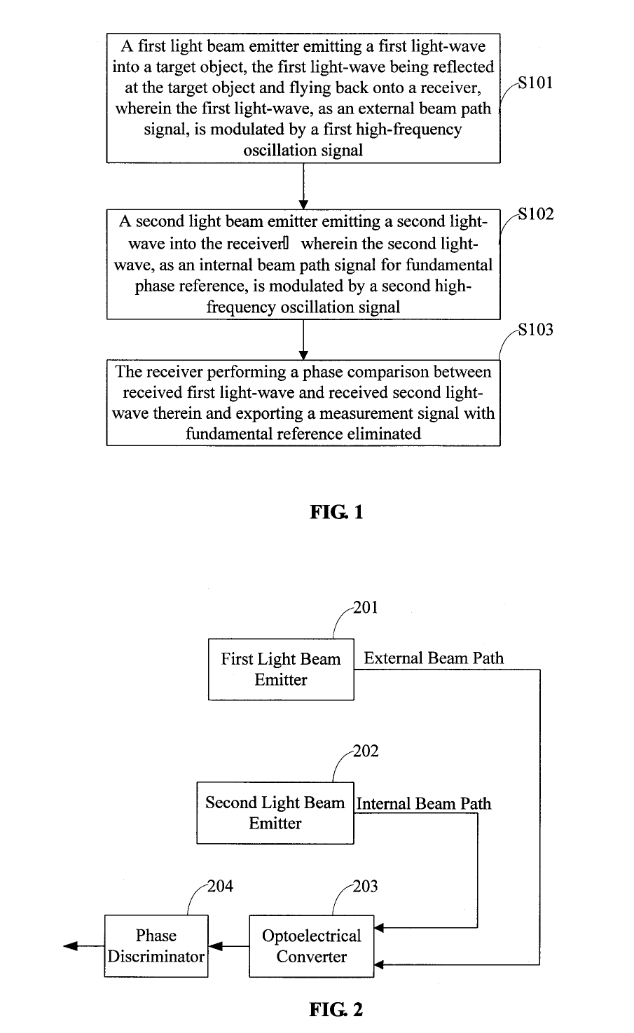

FIG. 1 shows an exemplary flow chart of the calibration method for phase measurement according to the embodiment of the present invention. The flow of the calibration method is described below in detail.

In step S101, a first light wave emitter emits a first light wave to a target object. The first light wave is reflected at the target object, flies back to onto a receiver and received by the receiver. The first light wave, as an external beam path signal, is modulated by a first high-frequency oscillation signal.

In step S102, a second light beam emitter emits a second light-wave into the receiver. The second light-wave, as an internal beam path signal for fundamental phase reference, is modulated by a second high-frequency oscillation signal.

In step S103, the receiver performs a phase comparison between received first light-wave and received second light-wave therein and exports a measurement signal with fundamental reference eliminated.

In this embodiment, the receiver separately mixes frequency of Mixing signals with the first and the second light-waves received in sequence. Then, the phase comparison is conducted between the two mixed light-waves with the Mixing signal. The Mixing signals separately mixing with the first and the second light-waves may be uniform high frequency oscillation signals. In an alternative embodiment, the Mixing signals could be two paths of high frequency oscillation signals having the same frequency, the same phase, or having a fixed phase margin.

In this embodiment, the two paths of light waves are laser.

In this embodiment, the two high-frequency oscillation signals, which respectively modulate the first and the second light waves as internal and external beam path signals, have the same frequency, the same phase, or have a fixed phase margin.

In this embodiment, the receiver may firstly receive the first light wave and sequentially the second light wave. In an alternative embodiment, the receiver could firstly receive the second light wave and sequentially the first light wave. In some embodiments, the receiver could be a device with photoelectric conversion function, such as for example, a photodiode, a photoelectric triode, an avalanche photo diode (APD), or a photomultiplier.

FIG. 2 shows operation principle of the calibration device for phase measurement adopting double-sending and single-receiving according to this embodiment of the present invention. For easy introduction, only parts relating to this embodiment are shown.

The first light-wave emitter 201 receives a first high frequency oscillation signal, generates a first light-wave which is modulated by the first high frequency oscillation signal, and emits modulated first light-wave as an external beam path signal into a target object. The second light-wave emitter 202 receives a second high frequency oscillation signal, generates a second light-wave which is modulated by the second high frequency oscillation signal, and emits modulated second light-wave as an internal beam path signal for fundamental reference and phase compensation. The optoelectrical converter receives and converts the second light-wave and/or the first light-wave which is reflected at the target object, then outputs the converted wave(s). The phase discriminator separately receives output signals from the optoelectrical converter and performs a phase comparison between the two signals, and then exports a measurement signal (i.e., phase margin signal) with fundamental reference eliminated.

In this embodiment, the first light wave emitter 201 and the second light wave emitter 202 both include a driver and a light emitting device. The light emitting device emits light wave under the driving of the driver. The light emitting device can be a laser diode (LD), a light emitting diode (LED), or other luminous units. In one embodiment, the first light wave emitter 201 and the second light wave emitter 202 may be laser beam emitters to emit laser.

In this embodiment, the second light wave emitter 202 may be collimated with respect to the optoelectrical converter 203 to facilitate direct incidence of light wave into the conversion device. In an alternative embodiment, a lens may be applied between the second light wave emitter 202 and the optoelectrical converter 203 to change light path, thereby facilitating receiving of the light wave in the conversion device 203. In another embodiment, a transporting passage, for example an optical fiber, may be connected between the second light wave emitter 202 and the optoelectrical converter 203.

In this embodiment, the optoelectrical converter 203 may be an optical-to-elec conversion device such as a photodiode, a photoelectric triode, an APD, or a photomultiplier.

In this embodiment, the receiver may firstly receive the first light wave and sequentially the second light wave. In an alternative embodiment, the receiver could firstly receive the second light wave and sequentially the first light wave.

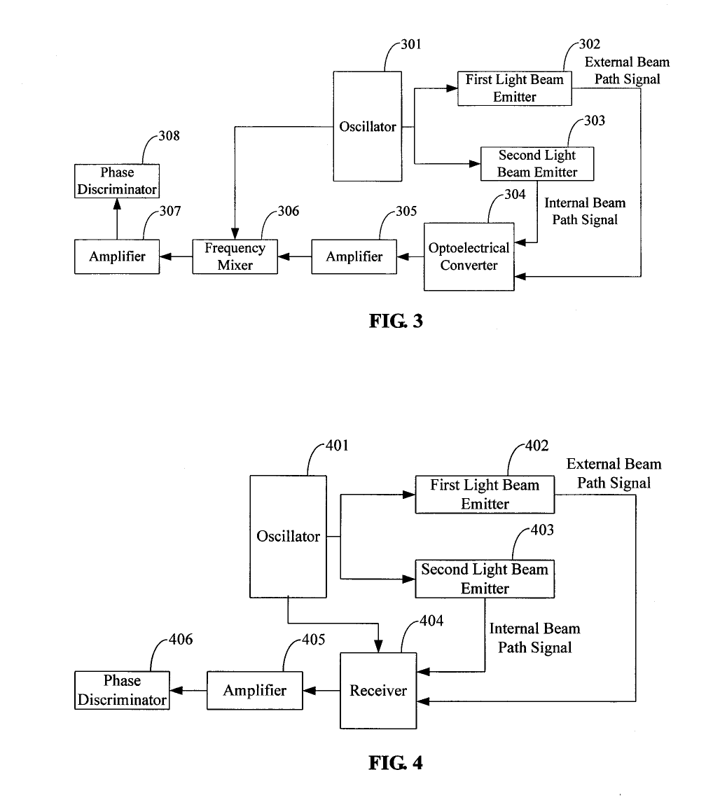

FIG. 3 shows a calibration device for phase measuring according to a first embodiment of the present invention. For easy explanation, only parts relating to this embodiment are shown. Compared with FIG. 2, this calibration device of FIG. 3 includes a first light wave emitter 302, a second light wave emitter 303, an optoelectrical converter 304, a phase discriminator 308, an oscillator 301, two amplifiers 305 and 307, and a frequency mixer 306. This device is used to generate and export high-frequency oscillation signals and mixing frequency signals.

The oscillator 301 generates a first high-frequency oscillation signal and a second high-frequency oscillation signal both having uniform frequency and phase. The first light wave emitter 302 receives the first high-frequency oscillation signal from the oscillator 301, and generates a light-wave which is modulated by the first high frequency oscillation signal, and emits modulated light-wave as an external beam path signal into a target object. The measure object reflects the external beam path signal. The optoelectrical converter 304 receives the reflected external beam path signal and exports an electrical signal (e.g., high-frequency electrical signal) after conversion. The amplifier 305 amplifies and exports the electrical signal from the converter 304. The mixer 306 receives signals from the amplifier 305 and mixes them with the Mixing signals exported by the oscillator 301, and then exports mixed frequency signals. The second light wave emitter 303 receives the second high-frequency oscillation signal from the oscillator 301, and generates a light-wave which is modulated by the second high frequency oscillation signal, and emits modulated light-wave as an internal beam path signal. The optoelectrical converter 304 receives internal beam path signal and exports an electrical signal (e.g., high-frequency electrical signal) after conversion. The exported electrical signal is amplified and exported by the amplifier 305. The mixer 306 receives signals from the amplifier 305 and mixes them with the Mixing signal exported by the oscillator 301 and finally exports two mix-frequency signals. These two mix-frequency signals are low-frequency electrical signals, which then go into another amplifier 307 to amplifying and exporting the two mix-frequency signals. The exported results are received by a phase discriminator 308 and are conducted a phase comparison therein. Consequently, a phase margin signal is exported.

In certain embodiments, the mixer 306 may be a device with frequency mixing function, such as for example, a photodiode, a photoelectric triode, an APD, and a photomultiplier.

In other embodiments, the optoelectrical converter 304 and the mixer 306 could be replaced with a receiver, which can simultaneously accomplishes both functions of optoelectrical converter 304 and the mixer 306. Specially, in an exemplary embodiment, the receiver is a device with frequency mixing function, such as for example, a photodiode, a photoelectric triode, an APD, and a photomultiplier.

In this embodiment, the amplifier 305 amplifies the received high-frequency electrical signals and has a high expense. The amplifier 307 amplifies the received low-frequency electrical signals and has relatively lower expense. While other parts of the circuit have good properties, one or both of the amplifiers 305 and 307 can be omitted. When a receiver is used to replace the optoelectrical converter 304 and the mixer 306, the amplifier 305 can be omitted. That is, the receiver replaces optoelectrical converter 304, the amplifier 305 and the mixer 306, and is connected to the amplifier 307 at output end thereof. The amplifier 307 is used to amplify low-frequency electrical signals, thereby cutting down the cost.

FIG. 4 shows a calibration device for phase measuring according to a second embodiment of the present invention. For easy explanation, only parts relating to this embodiment are shown. Compared with FIG. 3, the calibration device of FIG. 4 includes an oscillator 401, a first light wave emitter 402, a second light wave emitter 403, an amplifier 405, a phase discriminator 406, and a receiver 404. There receiver 404 is configured for separately receiving and converting the second light wave and the first light wave reflected back by the target object, respectively mixing them with the Mixed signal, and exporting two paths of mixed signals.

In this embodiment, the receiver 404 replaces the optoelectrical converter 304 and the mixer 306 in FIG. 3.

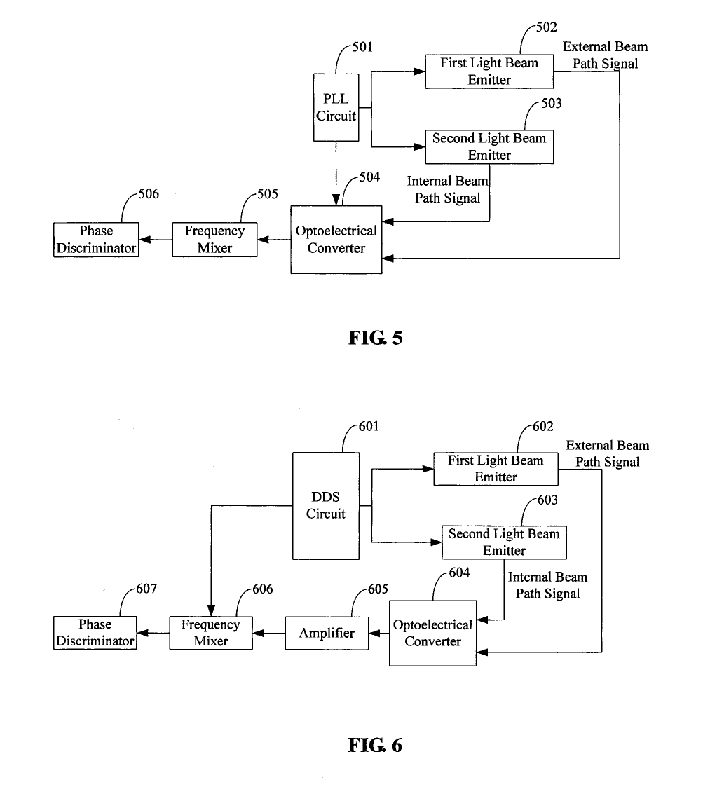

FIG. 5 shows a calibration device for phase measurement according to a third embodiment of the present invention. Compared with FIG. 3, this device of FIG. 5 includes a first light wave emitter 502, a second light wave emitter 503, an optoelectrical converter 504, a mixer 505 and a phase discriminator 506. The device adopts Phase Locked Loop (PLL) circuit 501 as an oscillator in FIG. 3, thereby avoiding use of the amplifier 305.

FIG. 6 shows a calibration device for phase measurement according to a fourth embodiment of the present invention. Compared with FIG. 3, this device of FIG. 6 includes a first light wave emitter 602, a second light wave emitter 603, an optoelectrical converter 604, an amplifier 706, a mixer 606 and a phase discriminator 607. The device adopts direct digital frequency synthesizer (DDS) circuit 601 as an oscillator in FIG. 3, thereby avoiding use of the amplifier 307.

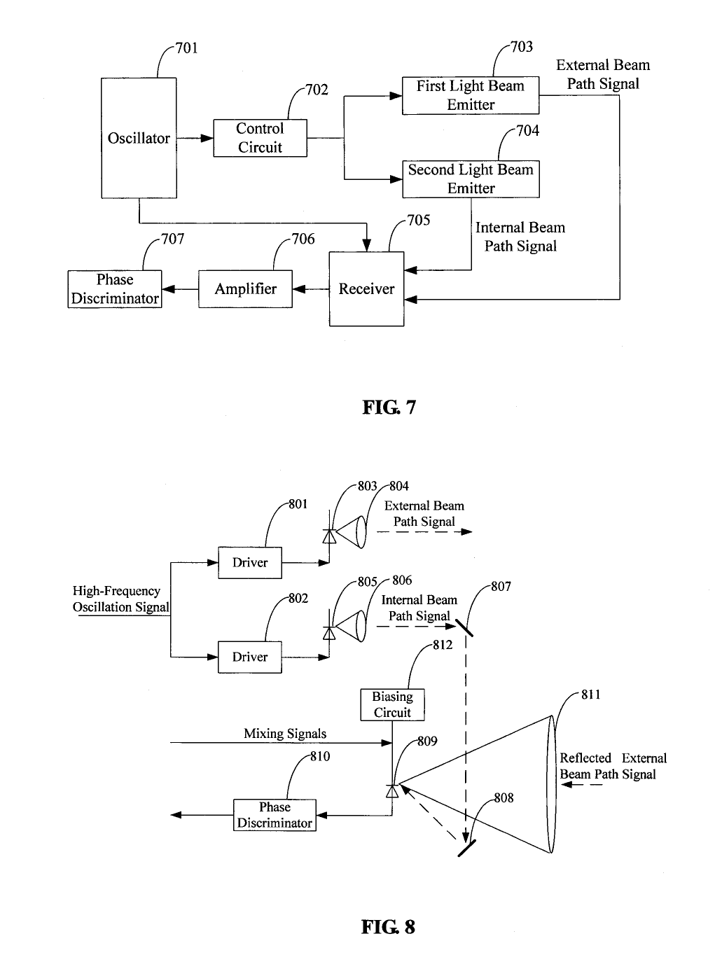

FIG. 7 shows a calibration device for phase measurement according to a fifth embodiment of the present invention. Compared with FIG. 4, this device of FIG. 7 includes an oscillator 701, a first light wave emitter 703, a second light wave emitter 704, a receiver 705, an amplifier 706, a phase discriminator 707 and a control circuit 702. The control circuit 702 is used to control emitting sequence of the first and the second light waves.

In this embodiment, the control circuit 702 is configured for controlling the on-off status or switch of internal and external light paths to control the emitting sequence of the first and second light waves and to ensure that the receiver 705 separately receives internal and external light path signals. In an exemplary embodiment, the control circuit 702 adopts a laser diode to obtain a nanosecond scale of switching interval. Specially, the control circuit 702 may be an analog switch, a metal oxide semiconductor field effect transistor (MOS FET) or a relay.

FIG. 8 shows a calibration device with a circuit for phase measurement according to a sixth embodiment of the present invention. The drivers 801 and 802 drive separately the first light wave emitter 803 and the second light wave emitter 805 in accordance with high-frequency oscillation signals to emit light waves. The emitted two paths of light waves respectively penetrate two lenses 804 and 806 and are incident into the internal and external light paths. The light wave emitted from the first light wave emitter 803 serves as an external light path signal. The light wave emitted from the second light wave emitter 805 serves as an internal light path signal. The internal light path signal is reflected or diffusely reflected by the speculum 807 and the speculum 808 onto the receiver 809. The receiver 809 conducts photoelectric conversion and frequency mixing between the internal light path signal and the Mixing signal, and exports the result to the phase discriminator 810. The flied back external light path signal penetrates the lens 811 and converges upon the receiver 809. The receiver 809 conducts photoelectric conversion and frequency mixing between the flied back external light path signal and the Mixing signal and exports the result to the phase discriminator 810. The phase discriminator 810 compares the phase of signals received in the two times and exports comparison result. A biasing circuit 812 is connected to the cathode of the receiver 809 to provide current for the base thereof.

In an certain embodiment, a lens can be applied between the second light wave emitter 805 and the receiver 809 to change light path, accordingly facilitating light wave receiving in the receiver 809. The second light wave emitter 805 can be collimated with respect to the receiver 809 so that the light wave can be directly incident into the receiver 809. A transporting passage, for example an optical fiber, may be connected between the second light wave emitter 202 and the optoelectrical converter 203.

In this embodiment, the drivers 801 and 802 both include the control circuit 702 shown in FIG. 7.

In this embodiment, the calibration device using double-sending and single-receiving can be applied in the calibration of distance measuring equipments, for example, continuous phase laser ranging equipments and impulse phase laser ranging equipments. The calibration device is usefully combined and connected with a distance measuring equipment to compensate difference such as phase margins generated in the distance measuring equipment circuit due to environmental elements.

In one embodiment, the calibration device using double-sending and single-receiving can be applied in distance measuring equipments with PLL circuit. Further, the calibration device can also be applied in distance measuring equipments with double crystal oscillations and double mixing frequencies or with DDS circuits.

In traditional method, a light wave emitter is applied to emit only one route of light wave, and a beam converting device is required to change light path and obtain internal and external light paths. However, the converting device generally has to conduct a multiple switching of the beam. The multiple switching typically requires a large mechanical load. This inevitably results in physical deterioration and a long circuit response time. Further, the adoption of beam converting device complicates the circuit, enlarges the volume and increases the cost. Compared with the traditional method, in this embodiment, control circuit can be applied to control on-off status or switch of the internal and the external light paths, thereby avoiding mechanical switch control. The response time of control circuit and the receiving interval of the internal and the external light path signals are short. Switch interval are in milliseconds. In such short time and interval, around environment can be seemed to be unchanged during circuit switch and thus produce little influence on the circuit and the resultant measuring precision.

In another traditional method, a light wave emitter is applied to emit one route of light wave and a beam splitting lens is required to simultaneously generate internal and external routes of light waves. Therefore, a double-APD receiver is required to receive two routes of light waves transmitted simultaneously. APD wastes circuit space and its expense is high. In comparison with this traditional method, in this embodiment, the present method adopts two light wave emitters to emit two routes of light waves and one receiver to achieve time-sharing receiving of light waves of internal and external light paths, thereby cutting down cost and reducing circuit space.

As described above, the calibration method of double-path sending and single-path receiving, in accordance with embodiments of the present invention, adopts two light wave emitters to separately emit internal and external light path signals and a signal receiver to separately receive the back signals of the internal and external light paths. The back signals of the internal and external light paths go through photoelectric conversion, frequency mixing, amplification and phase demodulation to export signals with fundamental reference signals eliminated. Accordingly, phase noise in circuit due to environment change is prevented. The control circuit controls the switch between the internal and external light paths, thereby achieving stably and rapidly phase margin compensation and calibration, reducing the influence of environmental elements on distance measurement errors, increasing measuring precision of laser ranging and distance measurement stability of the system, decreasing performance requirements on parts and thus reducing system cost (currently, the cost of a single-laser tube needs less than 0.4 USD) and reinforcing the application of laser ranging in various industries.

It is believed that the present embodiments and their advantages will be understood from the foregoing description, and it will be apparent that various changes may be made thereto without departing from the spirit and scope of the invention or sacrificing all of its material advantages, the examples hereinbefore described merely being preferred or exemplary embodiments of the invention.

What is claimed is:

1. A phase calibration method, comprising the steps of:
a first light beam emitter emitting a first light-wave into a target object, the first light-wave being reflected at the target object and flying back onto a receiver, wherein the first light-wave, as an external beam path signal, is modulated by a first high-frequency oscillation signal;
a second light beam emitter emitting a second light-wave into the receiver, wherein the second light-wave, as an internal beam path signal for fundamental phase reference, is modulated by a second high-frequency oscillation signal; and
the receiver performing a phase comparison between received first light-wave and received second light-wave therein and exporting a measurement signal with fundamental reference eliminated.

2. The method as claimed in claim 1, wherein the first and the second high frequency oscillation signals have the same frequency, the same phase, or have a fixed phase margin.

3. The method as claimed in claim 1, further comprising step of: the receiver separately mixing frequency of Mixing signals with the first and the second light-waves received in sequence prior to the phase comparison.

4. The method as claimed in claim 1, wherein the first and second light waves are laser.

5. A phase calibration device, comprising:
a first light-wave emitter configured for receiving a first high frequency oscillation signal, generating a first light-wave which is modulated by the first high frequency oscillation signal, and emitting modulated first light-wave as an external beam path signal into a target object;
a second light-wave emitter configured for receiving a second high frequency oscillation signal, generating a second light-wave which is modulated by the second high frequency oscillation signal, and emitting modulated second light-wave as an internal beam path signal for fundamental reference,
an optoelectrical converter configured for receiving and converting the second light-wave and/or the first light-wave which is reflected at the target object, then outputting the converted wave(s); and
a phase discriminator configured for separately receiving output signals from the optoelectrical converter and performing a phase comparison between the two signals, then exporting a measurement signal with fundamental reference eliminated.

6. The device as claimed in claim 5, further comprising a mixer configured for receiving the two signals output from the optoelectrical converter, and separately mixing frequency of Mixing signals with the first and the second light-waves received in sequence, and exporting signals with mixed frequency to the phase discriminator.

7. The device as claimed in claim 6, wherein the mixing high-frequency signal, which separately mixes with the two signals output from the optoelectrical converter, has the same frequency and phase, or have a fixed phase margin.

8. The device as claimed in claim 6, wherein the optoelectrical converter and the mixer are incorporated in a receiver, wherein the receiver is selected from the group consisting of: photodiode, photoelectric triode, avalanche photo diode, and photomultiplier.

9. The device as claimed in claim 6, wherein at least one of the optoelectrical converter and the mixer is selected from the group consisting of: photodiode, photoelectric triode, avalanche photo diode, or photomultiplier.

10. The device as claimed in claim 6, further comprising an oscillation configured for generating and outputting a high-frequency oscillation signal and/or the Mixing signal, and/or an amplifier configured for receiving and amplifying converted signal(s) from the optoelectrical converter, then exporting enhanced signals.

11. The device as claimed in claim 5, further comprising: a control circuit configured for controlling emission sequence of the first light-wave emitter and the second light-wave emitter.

12. A distance measuring equipment comprising a phase calibration device, the device comprising:
a first light-wave emitter configured for receiving a first high frequency signal, generating a first light-wave which is modulated by the first high frequency signal, and emitting modulated first light-wave as an external beam path signal into a target object;
a second light-wave emitter configured for receiving a second high frequency signal, generating a second light-wave which is modulated by the second high frequency signal, and emitting modulated second light-wave as an internal beam path signal for fundamental reference,
an optoelectrical converter configured for receiving and converting the first light-wave and/or the second light-wave in sequence, then transmitting and outputting the converted wave(s), wherein the first light-wave is reflected at the target object; and
a phase discriminator configured for separately receiving output signals from the optoelectrical converter and performing a phase comparison between the two signals, then exporting a measurement signal with fundamental reference eliminated.

13. The equipment as claimed in claim 12, further comprising a mixer configured for receiving the two signals output from the optoelectrical converter, and separately mixing frequency of Mixing signals with the first and the second light-waves received in sequence, and exporting signals with mixed frequency to the phase discriminator.

14. The equipment as claimed in claim 13, wherein the mixing high-frequency signal, which separately mixes with the two signals output from the optoelectrical converter, has the same frequency and phase, or have a fixed phase margin.

15. The equipment as claimed in claim 13, wherein the optoelectrical converter and the mixer are incorporated in a receiver, wherein the receiver is selected from the group consisting of: photodiode, photoelectric triode, avalanche photo diode, and photomultiplier.

16. The equipment as claimed in claim 13, wherein at least one of the optoelectrical converter and the mixer is selected from the group consisting of: photodiode, photoelectric triode, avalanche photo diode, or photomultiplier.

17. The equipment as claimed in claim 13, further comprising an oscillation configured for generating and outputting a high-frequency oscillation signal and/or the Mixing signal, and/or an amplifier configured for receiving and amplifying converted signal(s) from the optoelectrical converter, then exporting enhanced signals.

18. The equipment as claimed in claim 12, further comprising: a control circuit configured for controlling emission sequence of the first light-wave emitter and the second light-wave emitter.
